(19) United States
(12) Patent Application Publication
(10) Pub. No.: US 2009/0249955 A1
(43) Pub. Date: Oct. 8, 2009

(54) METHOD AND SYSTEM FOR SEPARATION OF GAS FROM LIQUID

(76) Inventor: Alan Izhar Bodner, Zichron Yaakov (IL)

Correspondence Address: THE NATH LAW GROUP, 112 South West Street, Alexandria, VA, 22314, US

(21) Appl. No.: 12/309,756

(22) PCT Filed: Jul. 31, 2007
(86) PCT No.: PCT/IL2007/000957

§ 371 Date: Jan. 29, 2009

Related U.S. Application Data
(60) Provisional application No. 60/834,534, filed on Aug. 1, 2006.
(60) Provisional application No. 60/841,299, filed on Aug. 30, 2006.

(51) Int. Cl. B01D 19/00

(52) U.S. Cl. 95/250; 96/193; 96/201; 96/193; 95/247

(57) ABSTRACT

A system for separation of gas from liquid disposed in a liquid source. The system comprising a liquid conveyance unit, a separation tank, a bubbler and a compressor. The liquid conveyance unit is adapted to convey liquid from the liquid source to the separation tank. The system further comprises a supersaturation device adapted to provide conditions for supersaturation of liquid disposed therein. The bubbler is adapted to produce gas bubbles and inject them into liquid supersaturated by the supersaturation device. The separation tank is adapted to cause a pressure reduction on liquid and gas therein to separate the gas from the liquid.

### FIELD OF THE INVENTION

This invention relates to a method and system for separation of gas from liquid, and more particularly to a method and system which uses a pressure reduction for such separation.

### BACKGROUND OF THE INVENTION

Liquids and gases are well known “states of matter”. However, it should be noted that dissolved gases in a liquid are also considered to be matter in a liquid state. Thus, in the specification and claims the term “liquid” or “liquid solution” means matter in a liquid state which may comprise a dissolved gas (for example, water comprising dissolved air).

One known application for which the separation of gas from liquid is used is for the supply of breathable air or oxygen to a predetermined destination such as an underwater chamber/diver/vehicle. Separation of gas from liquid to provide breathable air or oxygen may be accomplished with a gas exchanger or separation tank which utilizes a pressure reduction.

Gas exchangers are devices which transfer gases between a first body of matter and a second body of matter having different partial pressures of gases comprised therein, and they are known to be sometimes used for reoxygenation of stale air. In the specification and claims the term “stale air” is defined as air which is high in carbon dioxide and low in oxygen, relative to what is normally found in the atmosphere (e.g. air exhaled by a human). Examples of systems which use gas exchangers are disclosed in U.S. Pat. No. 3,333,583 and CA 2,030,804.

Additionally, it should be noted with regards to the provision of breathable air for underwater applications that normal air (constituted of about 21% nitrogen and about 78% oxygen) at certain depths may cause harmful effects to a person. Therefore, to avoid these harmful effects, divers often breathe Nitrox, which is air produced with contents of nitrogen and oxygen different from those in normal air (common recreational diving Nitrox mixtures are constituted of about 63-67% nitrogen and 32-36% oxygen).

A separation tank typically includes an interior construction which is adapted to induce a centrifugal flow of matter therein (i.e. a centrifuge) or an interior construction which is adapted to cause a volumetric increase and a separation plate for creating a pressure reduction on gas and liquid therein, and a gas outlet for the separated gas to exit therethrough. The separation tank is normally connected to a compressor, via the gas outlet, adapted to move separated gas out of the tank.

Pressure reduction on a gas-liquid mixture in a separation tank, may be a uniform reduction of pressure on the entire mixture, i.e. also known as a pressure drop, or may be a varied reduction of pressure on the liquid leaving different portions of the mixture adjacent to each other at different pressures, i.e. also known as a pressure gradient. For example centrifuges create a pressure gradient on the matter therein whereas separation tanks which comprise an interior construction which is adapted to cause a volumetric increase and a separation plate use a pressure drop. In either case the reduction of pressure in a separation tank causes gas therein to separate from the liquid therein. An example of a commercially available centrifuge for separating air from water is shown on the internet website http://www.bellgossett.com/productPages/Parts-Rolairtrol-Air-Separator-For-Hot-and-Chilled-Water.asp. An example of a commercially available separation tank comprising an interior construction which is adapted to cause a volumetric increase and includes a separation plate is shown on the internet website http://www.taconova.ch/tacoprod/taceprd5.htm#b53.

Systems for removal of air from water via the use of a separation tank and pressure reduction are disclosed in the applicant's US Application (Publication No. US-2004-0003811-A1), as well as U.S. Pat. No. 3,690,040 and U.S. Pat. No. 3,656,276.

It is important to note that gas exchangers and separation tanks work via different principles. Gas exchangers utilize the principle of equilibrium of partial pressures of gases in two bodies and exchange two gases between these bodies. For example, a gas exchanger may be provided with water as a first body and stale air as a second body. The gas exchange may occur via the removal of dissolved oxygen in the water, and the transfer thereof to the stale air, thereby reoxyginating the stale air, in return for carbon dioxide in the stale air being transferred to the water. The oxygen and carbon dioxide are transferred between the bodies in order to bring the partial pressures of these gases in the two bodies into equilibrium. By contrast, a separation tank causes a pressure reduction on a single liquid-gas mixture, dividing the mixture into its liquid and gas components.

It should be noted that separation of gas and liquid may also result in the provision of a gas-reduced liquid, which may have different uses, some examples of which are presented below.

Gas-reduced liquids may be useful for certain medical purposes. U.S. Pat. No. 6,503,225 discloses a device for removal of gas bubbles and dissolved gases from fluids delivered into a patient during medical procedures using gas permeable hollow fibers. Another known medical device, which provides gas-reduced liquid, is a deaerator, which boils feedwater to remove oxygen therefrom.

Gas-reduced potable liquids, for example, oxygen reduced juice, may have an extended shelf-life. U.S. Pat. No. 5,362,501 discloses a method for providing a gas-reduced liquid by removing oxygen from a solution. This method includes adding isolated oxygen scavenging membrane fragments from an organism of the genus Acetobacter to an acidic solution containing oxygen. Another method of reducing oxygen in a potable liquid, such as wine, is the introduction of nitrogen bubbles to the wine to add dissolved nitrogen to the wine and remove dissolved oxygen therefrom.

A device known for introducing gas bubbles into a liquid is a bubbler. Bubblers are known for various uses, for example for injecting carbon dioxide bubbles into drinks so that they become carbonated or aerating fish ponds.

### SUMMARY OF THE INVENTION

The present invention is based on the inventor's realization that an increase in the rate of separation of gas from a liquid in a separation tank which operates via the use of a pressure reduction can be achieved by supersaturating the liquid and adding gas bubbles to the supersaturated liquid.

It should be noted that a liquid is considered to be saturated with a dissolved gas, when it cannot dissolve more of that gas any longer. This state of liquid is also known as its saturation point. The saturation point of a given liquid may vary in accordance with the temperature and pressure conditions to which the liquid is subjected, and a change in these conditions (e.g. heating and/or reduction of pressure of a liquid) may cause the liquid to become supersaturated. When supersaturated, partial pressures of dissolved gases in a liquid are greater than that of the carrying liquid, causing a propensity of the dissolved gas to separate therefrom.

Thus, in accordance with the present invention it is suggested to provide conditions for supersaturating a liquid from which gas is to be separated, and to inject gas bubbles into the supersaturated liquid to accelerate phase change from gas dissolved in the liquid to a gas. This phase change is caused by the injected bubbles “capturing” the dissolved gas by providing it with a surface area, i.e. the outer surfaces of the bubbles, to latch onto, thereby creating new gas bubbles which are a combination of the injected bubbles and what was previously dissolved gas in the liquid. The new gas bubbles together with the liquid from which the dissolved gas was removed form a bubble-liquid mixture which is separated into gas and liquid components by the separation tank.

While it has been stated above that the bubbles should be injected into the supersaturated liquid, it should be noted that while injection of bubbles into liquid already supersaturated may be advantageous, the injected gas bubbles need not be injected into the liquid already supersaturated, but may even be injected further upstream at a stage where the liquid is not yet supersaturated, as long at least some of the injected bubbles reach the liquid at a point where it becomes supersaturated. This is because bubbles injected into a liquid behave in accordance with Henry's law, which states that “At a constant temperature, the amount of a given gas dissolved in a given type and volume of liquid is directly proportional to the partial pressure of that gas in equilibrium with that liquid.” Thus, if bubbles are injected into a liquid which is undersaturated, at least some of those injected gas bubbles may be dissolved into the liquid. Conversely, if bubbles are injected into a liquid which is oversaturated, the bubbles will not be dissolved into the liquid. Bearing this in mind it should be understood that while injection of bubbles into a liquid before the liquid is supersaturated may be less effective than injection of bubbles into a supersaturated liquid, it is still a viable possibility. Thus in the specification and the claims it should be understood that injection of bubbles into the supersaturated liquid includes an injection of bubbles into liquid which is about to be supersaturated, such that at least some of the injected bubbles will engage the liquid after the supersaturation thereof.

Thus, in accordance with a first aspect of the present invention there is provided a system for separation of gas from liquid disposed in a liquid source, the system comprising a liquid conveyance unit, a separation tank, a bubbler and a compressor; the liquid conveyance unit being adapted to convey liquid from the liquid source to the separation tank; the system further comprising a supersaturation device, which may particularly be the separation tank or the liquid conveyance unit, adapted to provide conditions for supersaturation of liquid disposed therein; the bubbler being adapted to produce gas bubbles and inject them into liquid supersaturated by the supersaturation device to form a liquid-bubble mixture; the separation tank comprising a gas outlet and being adapted to cause a pressure reduction on the liquid-bubble mixture when disposed therein to separate gas from said liquid; and the compressor being in fluid connection with the gas outlet and adapted to move gas out of the separation tank.

The supersaturation device may comprise a heating element and/or a pump for providing the conditions for supersaturation of liquid therein. The heating element may be adapted to heat liquid within the supersaturation device to a temperature below its boiling point, given that a desired liquid may become supersaturated at that temperature. The pump may be adapted to reduce pressure within the supersaturation device to a value which supersaturates a desired liquid in the supersaturation device.

The separation tank may comprise a centrifuge. Alternatively the separation tank may comprise an interior construction which is adapted to cause a volumetric increase and a separation plate for separating gas from the liquid disposed therein. The separation tank may comprise a porous pipe disposed therein for directing separated gas to the gas outlet. The separation tank may have an hourglass shape to increase the velocity of the liquid and gas therein at the narrow portion of the shape, thereby increasing the pressure gradient and facilitating separation of the gas from the liquid. The separation tank may comprise a baffle plate to prevent bubbles and/or separated air from moving in an undesired direction. The separation tank may comprise a liquid outlet and pump adapted to move fluid from the liquid source to the liquid outlet. In a case where the separation tank is intended to be used underwater, the liquid outlet may be oriented so as to provide means of propulsion of the separation tank's carrier.

The liquid conveyance unit may comprise a pipe in which, when used as supersaturation device, conditions may be provided for supersaturation of the liquid passing therethrough. For example, the pipe may be designed to provide a desired pressure reduction. The liquid conveyance unit may comprise other combinations of elements which are adapted to provide supersaturation conditions for a liquid therein. For example, the liquid conveyance unit may comprise a storage unit adapted to provide conditions for saturating liquid therein and a pipe via which the supersaturated liquid may be conveyed to a separation tank. In the latter example the liquid source may be located further upstream of the storage unit.

Experiments and calculations have shown that size of injected bubbles can affect their ability to capture the dissolved gases and that for effective phase change it is beneficial to maximize the surface area of injected gas bubbles which contacts supersaturated liquid within which they are disposed. Advantageous surface areas are calculated to be provided by bubbles having a diameter between the range of 1 P-5 mm. Thus, the system may use a bubbler of a type adapted to produce and inject bubbles of a diameter less then 5 mm, in particular in the range of 1μ-5 mm, still more particularly in the range of 5μ-80μ, and still more particularly in the range of 10μ-50μ. The bubbler may be made of a porous material, e.g. porous metal.

If the system is adapted to supply breathable air to a predetermined destination, i.e. when the gas separated from liquid by the system is in the form of a breathable air, the system may further comprise a conduit for providing fluid communication between the gas outlet and the predetermined destination. Examples of predetermined destinations are underwater habitats, underwater divers, firefighters, submersible vehicles, combustion engines. In case of underwater applications, the liquid would normally be from the environment, e.g. a water reservoir and the gas separated thereby may be Nitrox. Where the predetermined destination is a firefighter, the liquid may be from any appropriate source, for example the liquid may be transferred to the system via a firefighter's hose.

The system may further be adapted to provide gas from the predetermined destination to the bubbler. In such a case the system may comprise a conduit for this purpose. This feature may be useful when gas from the predetermined destination includes stale air, in which case the system may provide an additional function as an air exchanger. Systems for providing breathable air may also include a scrubber for improving the quality thereof.

If the system is adapted to provide gas-reduced liquid, the system may further comprise a conduit for providing fluid connection between the gas outlet and the atmosphere. The gas-reduced liquid may be a potable liquid. In which case the liquid may be wine or juice.

The gas-reduced liquid may be a liquid to be introduced to an internal site of a patient during a medical procedure or to process the water in a chiller.

According to another aspect of the present invention, there is provided a method for separating gas from liquid including:
a) supersaturating the liquid;
b) injecting bubbles into the supersaturated liquid to form a liquid-bubble mixture; and
c) causing a pressure reduction on the liquid-bubble mixture to separate gas from the liquid.

The liquid provided to the supersaturation device may be water or a potable liquid or a liquid adapted for use in a medical application.

The supersaturation of the liquid in the supersaturation device, and the introduction of bubbles thereto, may be by any appropriate ways, e.g. the ways mentioned above with respect to the first aspect of the invention.

Notably, if liquid is passed through a separation tank without supersaturating it or inducing a trigger or catalyst in the form of bubbles, only a relatively smaller amount of dissolved gas is separated therefrom. An example of how to measure and compare the relative difference is as follows:

In a first experiment:
providing a liquid source that comprises water;
measuring the temperature and amount of dissolved oxygen of the water in the liquid source using a thermostat and a commercial dissolved oxygen meter;
conveying the water from the liquid source to a separation tank via a liquid conveyance unit;
supersaturating the water by raising the temperature thereof to an amount which is known to supersaturate the water;
injecting bubbles into the water via a bubbler, creating a bubble-liquid mixture;
using a separation tank to separate air and air-reduced liquid from the mixture via a pressure reduction;
measuring the air-reduced water which exits the separation tank with a second dissolved oxygen meter and a temperature gauge to determine the quantity of dissolved oxygen removed from the water (using a chart which indicates for a given temperature what the quantity of dissolved oxygen in the liquid should be for the two measured temperatures); and
estimating the total amount of dissolved gas removed from the water using the measured quantity of dissolved oxygen removed from the water as a basis for calculations.

In a second experiment:
providing a liquid source that comprises water;
measuring the temperature and amount of dissolved oxygen of the water in the liquid source using a thermostat and a commercial dissolved oxygen meter;
passing the water through the same system used in the previous example without supersaturating it (i.e. without heating it) and without injecting bubbles therein;
using a separation tank to separate air and air-reduced liquid from the mixture via a pressure reduction;
measuring the air-reduced water which exits the separation tank with a second dissolved oxygen meter and a temperature gauge to determine the quantity of dissolved oxygen removed from the water (using a chart which indicates for a given temperature what the quantity of dissolved oxygen in the liquid should be for the two measured temperatures); and
estimating the total amount of dissolved gas removed from the water using the measured quantity of dissolved oxygen removed from the water as a basis for calculations.
Thus the results for the two above described experiments can be compared to determine relative differences in performance.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a block diagram of an example of a system in accordance with the present invention;

FIG. 1B is a block diagram of one embodiment of the system in FIG. 1A;

FIG. 1C is a block diagram of another embodiment of the system in FIG. 1A;

FIG. 2A is a schematic view of an example of a system, including a centrifuge, in accordance with the present invention;

FIG. 2B is a schematic internal view of a top portion of the centrifuge in FIG. 2A;

FIG. 3 is a schematic view of a further example of a system in accordance with the present invention;

FIG. 4 is a schematic view of a yet another example of a system in accordance with the present invention;

FIG. 5 is a schematic view of a separation tank which may be used in a system according to the present invention;

FIG. 6A is a schematic view of a diver using a system in accordance with the present invention;

FIG. 6B is a schematic view of a firefighter using a system in accordance with the present invention; and

FIG. 6C is a schematic view of a medical patient using a system in accordance with the present invention.

### DETAILED DESCRIPTION OF EMBODIMENTS

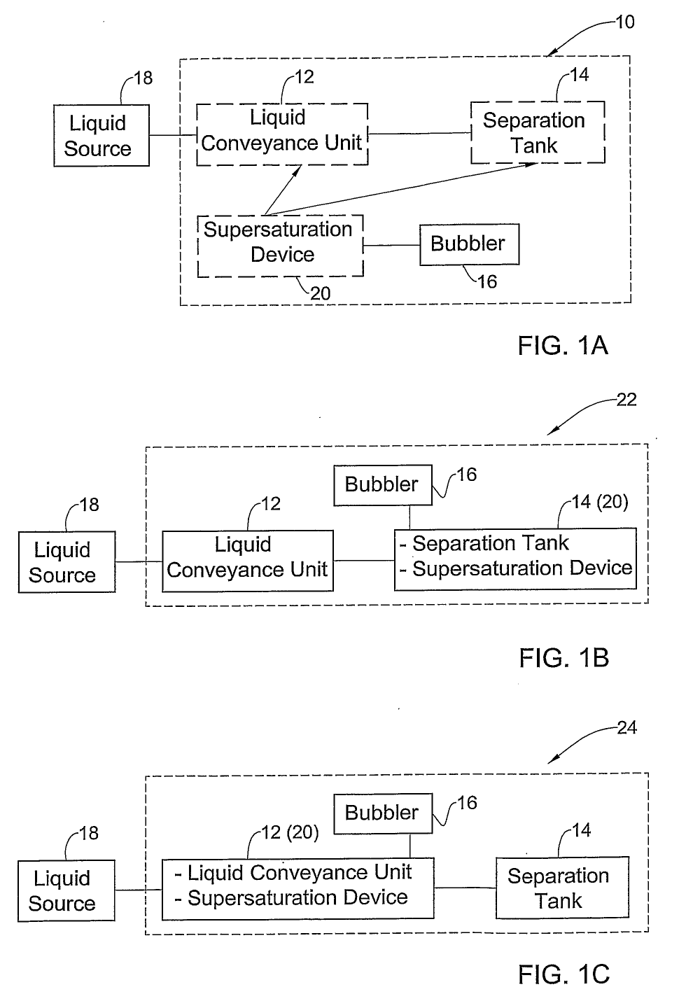

Referring now to the drawings wherein like reference characters designate like or corresponding parts throughout the several views, there is schematically shown in FIG. 1A one example of a system generally designated 10 for separating gas and liquid in accordance with the present invention.

The system 10 comprises a liquid conveyance unit 12, a separation tank 14 and a bubbler 16. The liquid conveyance unit 12 is adapted to convey liquid (not shown) from the liquid source 18 to the separation tank 16. The separation tank 14 may be of a commercially available type and is adapted to cause a pressure reduction on matter therein. The bubbler 16 may be of a commercially available type, and is adapted to produce and inject gas bubbles (not shown) into liquid.

Either the separation tank 14 or the liquid conveyance unit 12 constitutes a supersaturation device 20. This option is indicated by the two arrows shown. The separation tank 14 or the liquid conveyance unit 12, when in the form of the supersaturation device 20, is adapted to provide conditions for supersaturation of liquid disposed therein by reducing the liquid's pressure or increasing the liquid's temperature. The bubbler 16 is adapted to inject bubbles into liquid in the supersaturation device 20. The position of the bubbler 16 for both the above alternatives of the supersaturation device 14(20) and 12(20) is shown in FIGS. 1B and 1C, in the arrangements generally designated there by the numerals 22 and 24, respectively.

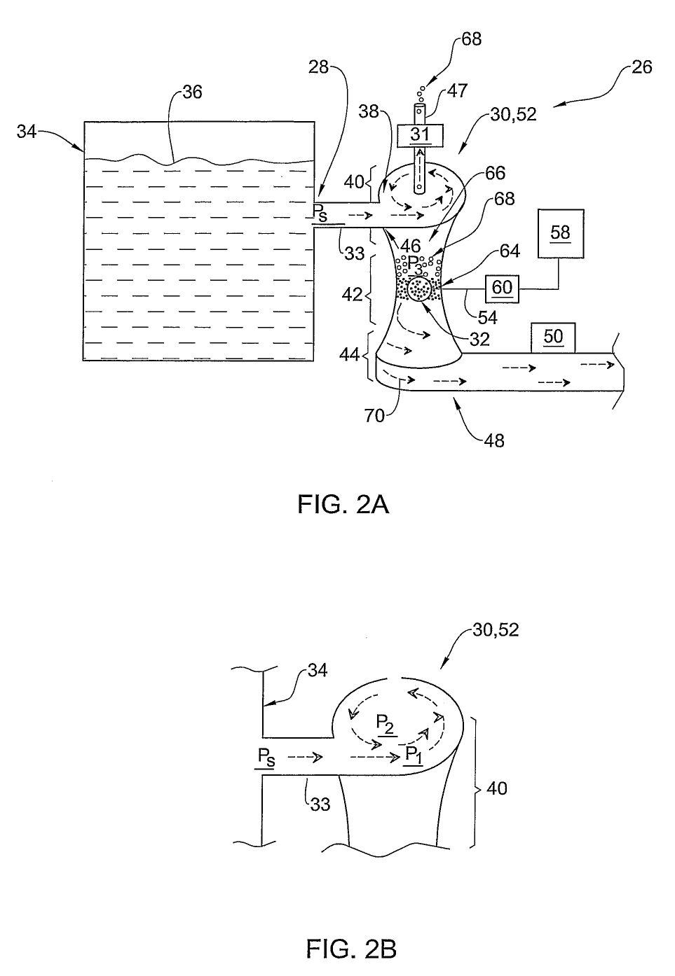

In FIG. 2A there is illustrated an example of a system, generally designated as 26, with the arrangement 22 in FIG. 1B, the system 26 comprising a liquid conveyance unit 28, a separation tank 30, a compressor 31 and a bubbler 32.

The liquid conveyance unit 28 comprises a relatively short pipe 33 in fluid connection with a liquid source in the form of a water reservoir 34 comprising water 36. At the area of engagement of the short pipe 33 and the water reservoir 34, pressure of the water 34 is designated as PS.

The separation tank 30 is an hourglass-shaped centrifuge in fluid connection with the short pipe 32. The centrifuge 30 is substantially cylindrical and comprises an inner surface 38, a wide upper portion 40, a narrow middle portion 42, and a wide lower portion 44. The upper portion 40 comprises an inlet 46, tangential with the inner surface 38 at the upper portion 40, and a gas outlet 47. The lower portion 44 comprises a liquid outlet 48. The liquid outlet 48 is provided with a system pump 50 mounted thereon and in fluid connection therewith to move liquid out of the separation tank 30.

The compressor 31 is in fluid communication with the gas outlet 47, and is adapted for moving gas out of the separation tank 30.

The bubbler 32 is disposed in the middle portion 42 of the separation tank 30 and is in fluid connection therewith. The system 26 further comprises a gas pump 60 and a conduit 54 connecting the bubbler 32 to the atmosphere 58 via the gas pump 60. The bubbler 32 is a ring-shaped porous metal bubbler, such as e.g. sold by GKN Sinter Metal Filters GmbH, Dahlienstrasse 43, Radecormwald, Germany, under the trade name “SIKA-R10”, and is adapted to produce an outgoing flow of bubbles of a diameter of about 10 μm. It should be noted, however, that any other bubbler adapted to produce a uniform outgoing flow of bubbles of a diameter in the range of 1μ-5 mm may also be acceptable. Calculations and experiments regarding bubbles' size have shown that a bubble diameter of within 5μ-80μ and optimally within the range of 10μ-50μ may provide superior results, for a purpose which will be described hereinafter, to bubbles having a diameter outside of these ranges. Calculations and experiments have also shown that even a mixture of bubbles of different diameters within these ranges may still provide reasonable results.

In operation the system pump 50 is activated to draw water 36 from the water reservoir 34 via the short pipe 33 into the inlet 46 of the separation tank 30, where it spirals downwards towards the liquid outlet 48. The flow of the water 36 and gas separated therefrom is indicated via the use of dotted arrows.

Turning attention to FIG. 2B, the flow of the water 36 entering the upper portion 40 of the separation tank 30 is shown in more detail. The water 36 is exposed to centrifugal force as it begins to spiral downward in the centrifuge 30. The spiral flow is relatively laminar and allows the water 36 to have a pressure which varies in accordance with the radial distance from the inner surface 38. Two example points of pressure designated as P₁ and P₂ are shown. P₁ is close to the inner surface 38 and P₂ is near the center of the upper portion 40 and distant from the inner surface 38, comparative to P₁. The pressure of the fluid at point P₂ is lower than the pressure of the fluid at point P₁ due to the greater radial distance between the inner surface 38 and P₂. Reverting to FIG. 2A, when the fluid reaches the point designated as P₃ the pressure thereof is substantially less than the pressure in the water reservoir Pₛ and the water becomes supersaturated with respect to dissolved air therein. In this example, the above pressure values in the system 26 may be as follows: Pₛ=1 bar, P₁=0.28 bar and P₂=0.23 bar. Thus, in the present example, the separation tank 30 performs the function of a supersaturation device.

The gas pump 60 supplies air from the atmosphere 58 to the bubbler 32. The bubbler 32 produces a uniform flow of air bubbles 64 and injects this flow into the supersaturated water in the separation tank 30, as a screen of fine air bubbles, which mixes with the water 36, and creates new bubbles 68, which together with the water 36 form a bubble-water mixture 66. The centrifuge 30 causes the bubble-water mixture 66 to also follow a spiral motion and to encounter a pressure reduction, in the form of the varying radial pressure, which facilitates separation of bubbles 68 from the mixture 66 and produces air-reduced water 70. The compressor 31 causes the created bubbles 68 to move from the center of the centrifuge 30 to the gas outlet 47, whilst the pump 50 causes the air-reduced water 70 to exit via the liquid outlet 48.

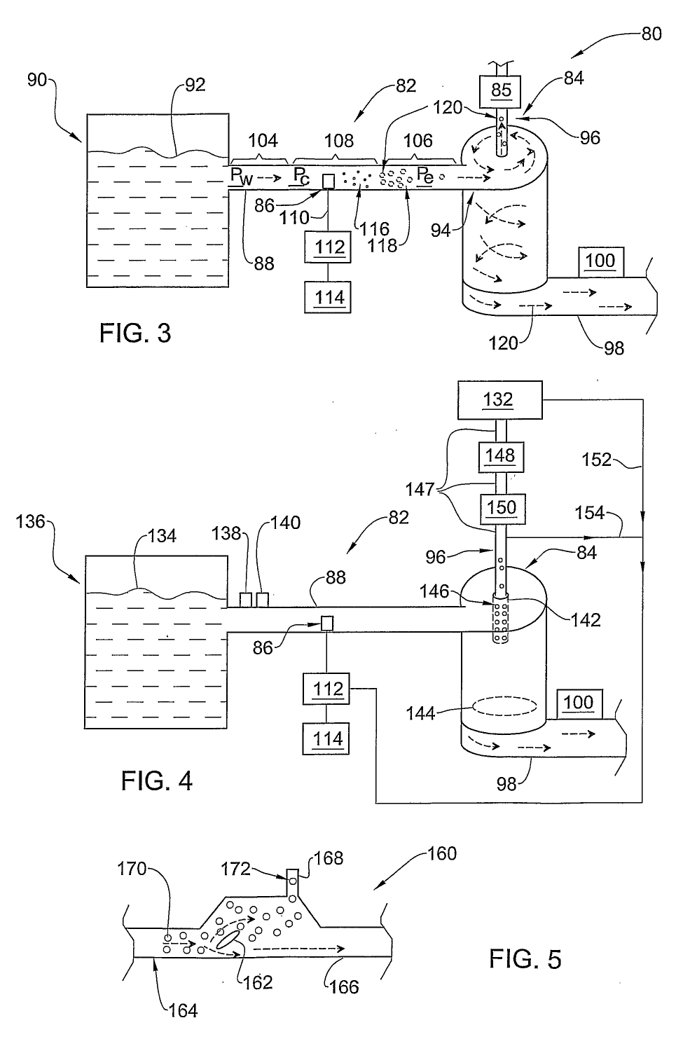

In FIG. 3 there is illustrated an example of a system, generally designated as 80, with the arrangement 24 in FIG. 1C, the system 80 comprising a liquid conveyance unit 82, a separation tank 84, a compressor 85 and a bubbler 86.

The separation tank 84 is a centrifuge comprising an inlet 94, a gas outlet 96, and a liquid outlet 98. The liquid outlet 98 has a system pump 100 mounted thereon and in fluid connection therewith.

The liquid conveyance unit 82 comprises a relatively long pipe 88 providing fluid connection between a liquid source in the form of a wine vat 90 comprising wine 92, and the inlet 94 of the separation tank 84. The pipe 88 comprises a proximal portion 104, a distal portion 106 and a central portion 108 extending therebetween, and it has such a length as to provide in a fluid passing therethrough a pressure gradient required for supersaturation of the fluid (as will be described in more detail below). For example, the length of the pipe 88 may be about four meters. At the area of engagement of the long pipe 88 and the wine vat 90, pressure of the wine 92 is designated as P_{w}.

The bubbler 86 is disposed so as to be in fluid connection with the central portion 108 of the liquid conveyance unit 82. The system 80 further comprises a gas pump 112 and a conduit 110 to provide therethrough air from the atmosphere 114 to the bubbler 86.

In operation the system pump 100 is activated and draws wine 92 from the wine vat 90 via the long pipe 88 into the inlet 94 of the separation tank 84, where it spirals downwards towards the liquid outlet 98. The flow of the wine 92 is indicated via the use of arrows. The pressure of the wine 92 in the pipe 88 decreases as it flows from the vat 90 to the inlet 94 of the centrifuge 84, supersaturating the wine 92 in the pipe 88, which thus constitutes a supersaturation device. This pressure decrease on the wine 92 is due to friction caused by the flow through the pipe 88, and it can be calculated via standard equations. Example of pressure values of the wine 92 which are P_{w} mentioned above, P_{c} at a central point in the pipe 88, and Pₑ at an engagement point of the pipe 88 with the centrifuge 84, are P_{w}=1 bar, P_{c}=0.75 bar and Pₑ=0.2 bar.

The gas pump 112 supplies air from the atmosphere 114 to the bubbler 86. The bubbler 86 produces air bubbles 116 and injects them into the supersaturated wine in the pipe 88, creating new bubbles 120 in the wine and thus a bubble-wine mixture 118 which enters the centrifuge 84 via the inlet 94 thereof. The centrifuge 84 subjects the bubble-wine mixture 118 to a pressure reduction, separating the created bubbles 120 and air-reduced wine 122 in the mixture 118. The compressor 85 moves the separated created bubbles 120 out of the gas outlet 96.

It should be noted that the friction in the pipe causes a turbulent flow of the matter therein which is beneficial for ensuring that injected bubbles 116 thoroughly mix with the supersaturated wine 92. Furthermore, while a pipe constituting a liquid conveyance unit could be shorter, it has been found that a longer pipe has the benefit of allowing turbulated fluid therein to thoroughly mix with injected bubbles, more efficiently creating a bubble-liquid mixture. Thus pipes of even longer length may prove more effective, dependent on the requirements of specific systems in which they are used. Similarly, while a bubbler may be placed in any portion of the pipe 88, given that the bubbles engage supersaturated liquid therein at some stage, the central portion 108 is believed to allow the injected bubbles 116 a sufficient period of time to engage the supersaturated wine 92 and effect a phase change in the wine 92 thus removing dissolved air therefrom (not shown) to create the bubble-liquid mixture 118 before the supersaturated wine 92 is exposed to a pressure reduction in the separation tank 84.

One advantage of system 80 over the previous system is that it comprises two separate components of the system for creating the phase change of dissolved gas to gas and the separation of gas from liquid. This is advantageous because:
for effective phase change it is beneficial to have a mixture of injected bubbles and supersaturated liquid subjected to turbulation and as large a pressure reduction as possible (i.e. two effects which can be produced in the pipe), whereas for effective separation of gas from liquid in a separation tank it is beneficial for the pressure reduction to be in the form of a pressure gradient and for the gas and liquid to be in a laminar flow, facilitating the separation thereof (i.e. two effects which can be produced in the centrifuge); and
for effective phase change from a dissolved gas to a gas injected bubbles of a small diameter are preferred, as explained above, whereas for effective separation of gas from liquid in a bubble-liquid mixture in a separation tank, it is beneficial for a bubble-liquid mixture to comprise bubbles of as large a diameter as possible which separate from liquid more easily than bubbles.

It should be mentioned that where the liquid conveyance unit constitutes a supersaturation device, the liquid conveyance unit may comprise additional elements such as a storage tank which is adapted to provide supersaturation conditions for a liquid therein. By way of example, in FIG. 3, the wine vat 90 could have been adapted to supersaturate the wine 92 therein, in which case the liquid conveyance unit of the system shown in FIG. 3 would comprise both the wine vat 90 and the pipe 88 and the liquid source for providing liquid which is not yet supersaturated would be an element (not shown) disposed upstream of the wine vat 90.

As can be understood by one skilled in the art, the systems described above, as well as any other system in accordance with the present invention, may include additional elements to provide the supersaturation conditions in a supersaturation device or to suit the system to a particular application.

With reference to FIG. 4 there is seen a further example of a system, generally designated as 130, adapted to provide breathable air from seawater 134 taken from a sea 136, to a predetermined destination in the form of a chamber 132 of an underwater habitat.

System 130 comprises elements identical to those described with respect to FIG. 3 and a number of optional additional elements.

In particular, in the system 130, the liquid conveyance unit 82 further comprises a heating element 138 and a pressure pump 140, both of which being in fluid connection with the long pipe 88.

The separation tank 84 further comprises a porous pipe 142 and a baffle plate 144. The porous pipe 142 is formed with pores 146 which are of a size to allow separated bubbles to pass therethrough, and is formed with an open top in fluid connection with the gas outlet 96. The baffle plate 144 is adapted to prevent gas from exiting via the liquid outlet 98.

The system 130 further comprises a first conduit 147 to provide fluid communication between the gas outlet 96 and the chamber 132, a scrubber 148 mounted on and in fluid communication with the first conduit 147, a compressor 150 mounted on and in fluid communication with the first conduit 147, a second conduit 152 to provide fluid communication between the gas pump 112 and the chamber 132, and a third conduit 154 to provide fluid communication between the gas outlet 96 and the gas pump 112.

In operation the system 130 separates gas from liquid in a similar manner to that described with reference to the system 80 in FIG. 3. Extra operational features are as follows:
Regarding the provision of supersaturation conditions in the pipe 88, it should be noted that the seawater 134 therein may also be supersaturated via operation of the heating element 138 heating the seawater 134, and/or the pressure pump 140 reducing the pressure of the seawater 134. Notably, as the provision of bubbles is by the bubbler 86, there is no need for the heating element 138 to bring the seawater 134 to boiling point for the provision of bubbles. This is advantageous as boiling a liquid may require a large amount of energy. Thus a heating element used with the present invention may be adapted to heat liquid within the supersaturation device to a temperature below boiling point, i.e. to a temperature sufficient supersaturate the liquid, for example the heating element may be adapted to heat the water to 30 degrees Celsius.
Regarding the separation tank 84, any bubbles therein are prevented from exiting the liquid outlet 98 by the baffle plate 144 and are instead drawn out of the separation tank 84 via the pores 146 of the porous pipe 142 and the gas outlet 96 via operation of the compressor 150.
Regarding the scrubber 148, separated air (not shown) from the separation tank 84 flows through the scrubber 148, which enhances its quality for breathing, to the chamber 132.
Regarding the bubbler 86, gas may be supplied thereto in the form of stale air from the chamber 132 via the second conduit 152 and/or via separated air via the third conduit 154 and/or from the atmosphere 114 as in the previous examples. When stale air is supplied to the bubbler 86, the system 130 also removes excess carbon dioxide into the seawater 134 via gas exchange.

With reference to FIG. 5, there is shown another type of commercially available separation tank, generally designated as 160, which utilizes an interior construction which is adapted to cause a volumetric increase and includes a separation plate for causing pressure reduction in the form of a pressure drop to separate bubbles from liquid. The separation tank 160 comprises a separation plate 162, an inlet 164, a liquid outlet 166 and a gas outlet 168.

In operation a bubble-liquid mixture 170, the flowpath of which is indicated by arrows, enters the tank 160 via the inlet 164. The tank 160 which has a larger volume than the inlet 164, and therefore the bubble-liquid mixture 170 leaving the inlet 164 and entering the tank 160 is exposed to a volumetric increase along its flowpath. The mixture 170 then passes the separation plate 162, which is slanted with respect to the initial direction of the flowpath and thus causes a pressure difference on the mixture passing above and below the plate 162, separating bubbles 172 from the mixture 170 by redirecting them upwardly. The separated bubbles 172 exit the tank 160 via the gas outlet 168 and the gas-reduced liquid exits the tank 160 via the liquid outlet 166.

It should be noted that the composition of dissolved air in water with respect to nitrogen and oxygen therein is approximately 63% and 34%, respectively. Thus, air separated from water in accordance with the above described method or systems, has a constitution similar to Nitrox. One advantage of this system is that it is thus particularly useful for providing oxygen enriched air (i.e. Nitrox) to underwater destinations because the source of the breathable air will be always located adjacent thereto and likely in a high or limitless supply.

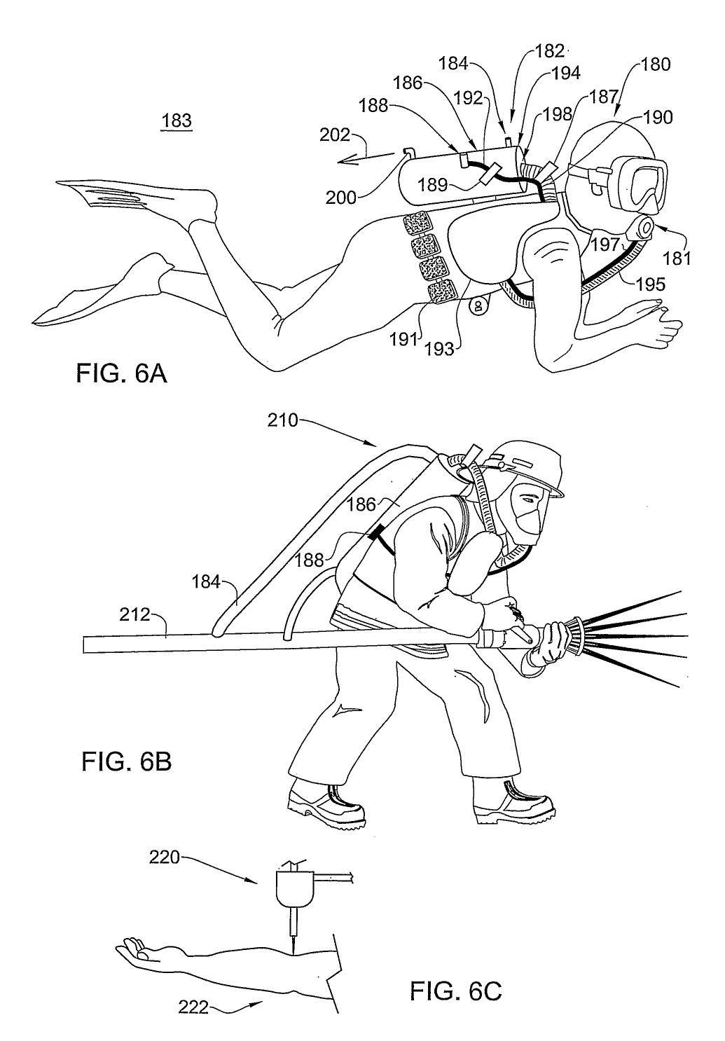

Referring to FIG. 6A, there is shown a diver 180 wearing a diver's mouthpiece 181 and a system generally designated as 182, swimming in a liquid source constituted body of water 183.

System 182 comprises a liquid conveyance unit 184, a separation tank 186, a compressor 187, batteries 191 for powering the compressor and pump (not shown), a bubbler 188, a pump, a compressed air tank 189, a first conduit 190, a second conduit 192, an air bag 193, a third conduit 195 and a fourth conduit 197.

The separation tank 186 is a centrifuge and it comprises an inlet 194, a gas outlet 198 and a liquid outlet 200.

The compressed air tank 189 is in fluid connection with the bubbler 188 and is adapted for providing gas thereto.

The first conduit 190 provides fluid connection between the gas outlet 198 and the air bag 193. The second conduit 192 provides fluid connection between the air bag 193 and the bubbler 188. The third conduit 195 provides fluid connection between the air bag 193 and the diver's mouthpiece 181. The fourth conduit 197 provides fluid connection between the diver's mouthpiece 181 and the air bag 193.

In operation the water from the body of water 183 is suctioned into the separation tank 186, by the pump, via the liquid conveyance unit 184. The water is supersaturated in the separation tank 186. The bubbler 188 receives air from the compressed air tank 189, produces bubbles and injects them into the tank 186 creating a bubble-liquid mixture (not shown). It should be mentioned that the compressed air tank 189 may be used only to provide an initial dose of air to a bubbler or, alternatively, it may serve also as a backup air supply in case of a system failure. Example volume capacities of the tank for the former use may be about 10 cc and for the latter use may be about 1 liter.

The bubble-liquid mixture (not shown) is subjected to pressure reduction in the tank 186, whereby air is separated from the mixture as described above with respect to previous examples. The separated air is moved by the compressor 187 through the gas outlet 198 and conveyed by the first conduit to the air bag 193 which acts as a buffer between the tank 186 and the diver's mouthpiece 181, since the diver's breathing rate is not constant. The separated air is then breathed in by the diver via the third conduit 195 and the diver's mouthpiece 181 and the stale breathed air is expelled via the fourth conduit 197 back to the air bag 193. The diver's stale exhaled air (not shown) in the air bag 193 is conveyed to the bubbler 188 via the second conduit 192, wherein the stale air is used by the bubbler 188 to produce bubbles which are injected into the tank 186. It should be noted that the diver's mouthpiece 181 could additionally or alternatively be in direct fluid communication with the bubbler 188, for example via a conduit (not shown), for supplying stale air directly thereto. In such case the second conduit 192 and the fourth conduit 194 would be replaced by a single conduit (not shown). Reverting to the example shown, air-reduced water is expelled from the tank via liquid outlet 200 in the direction of arrow 202, enabling its use as a propulsion means for the diver 180. Notably the liquid outlet may be designed in such a way as to allow desired orientation of the outgoing water. It should also be noted that the system 182 is thus a closed-circuit system wherethrough stale air is recirculated. System 182 may also include, in addition to the elements described hereinabove, other elements described in the Applicant's US Application (Publication No. US-2004-0003811-A1) such as a scrubber, unidirectional valves etc, whose description therefrom is incorporated herein by reference.

Referring to FIG. 6B, a system generally designated as 210 is shown being used by a firefighter. The system 210 is similar to the system 182 described with reference to FIG. 6A. However in the system 210 the liquid source is constituted by water in a firefighter's hose 212.

Referring to FIG. 6C, a system generally designated as 220 is shown being used for providing a gas reduced liquid for a medical application. The gas-reduced liquid is being introduced to an internal site of a patent 222 during a medical procedure. Such liquid may be, for example, a drug, an anesthetic, blood, saline, flush solution, a marker dye, intravenous nutrients, bioactive fluids or soluble medications. System 220 may be similar to the systems described above.

Those skilled in the art to which this invention pertains will readily appreciate that numerous changes, variations and modifications can be made without departing from the scope of the invention mutatis mutandis. It should be appreciated that the present invention may apply to any number of gases and liquids that may have industrial applicability, e.g. Freon. Additionally, the system may comprise valves where necessary to control direction of gas or liquid flows.

1. A system for separation of gas from liquid disposed in a liquid source, the system comprising a liquid conveyance unit, a separation tank, a bubbler and a compressor; the liquid conveyance unit being adapted to convey liquid from the liquid source to the separation tank; the system further comprising a supersaturation device, which may particularly be the separation tank or the liquid conveyance unit, adapted to provide conditions for supersaturation of liquid disposed therein; the bubbler being adapted to produce gas bubbles and inject them into liquid supersaturated by the supersaturation device to form a liquid-bubble mixture; the separation tank comprising a gas outlet and being adapted to cause a pressure reduction on the liquid-bubble mixture when disposed therein to separate gas from said liquid; and the compressor being in fluid connection with the gas outlet and adapted to move gas out of the separation tank.

2. (canceled)

3. The system according to claim 1, wherein the bubbler is adapted to produce bubbles of a diameter between 5μ and 80μ.

4. (canceled)

5. The system according to claim 1, wherein the bubbler is made of porous material.

6. The system according to claim 1, wherein said supersaturation device further comprises a heating element for providing said conditions for saturation of liquid disposed therein, the heating element being adapted to heat the liquid in the supersaturation device until it becomes supersaturated.

7. The systems according to claim 6, wherein said heating element is adapted to heat liquid within the supersaturation device to a temperature below boiling point.

8. (canceled)

9. The system according to claim 1, wherein said supersaturation device is the liquid conveyance unit, which comprises a pipe; wherein said pipe has a length allowing to subject liquid therein to a pressure reduction required for supersaturation of the liquid.

10-14. (canceled)

15. The system according to claim 1, wherein said separation tank is a centrifuge and the separation tank has an hourglass shape.

16. The system according to claim 1, wherein said separation tank comprises an interior construction which is adapted to cause a volumetric increase and a separation plate for separating gas from the liquid disposed therein.

17-18. (canceled)

19. The system according to claim 1, wherein said separation tank further comprises a porous pipe disposed therein for causing gas separated from the bubble-liquid mixture in the separation tank to exit via said gas outlet.

20. The system according to claim 1, wherein said separation tank further comprises a liquid outlet and a baffle plate adapted to prevent gas separated from the bubble-liquid mixture from exiting via the liquid outlet.

21. The system according to claim 1, said system further comprising a conduit to provide fluid communication between said gas outlet and said bubbler.

22. The system according to claim 1, adapted to supply breathable air to a predetermined destination, said system further comprising a conduit to provide fluid communication between said gas outlet and the predetermined destination.

23. The system according to claim 22, further comprising a conduit to provide fluid communication between said predetermined destination and said bubbler.

24. The system according to claim 22, further comprising a scrubber in fluid communication with said gas outlet.

25. The system according to claim 22, wherein said separation tank further comprises a liquid outlet which may be oriented so as to provide means of propulsion.

26. (canceled)

27. The system according to claim 1, constituting a subsystem of a firefighter's machine, the machine further comprising a liquid source in the form of a firefighter's hose.

28. The system according to claim 1, constituting a subsystem of a medical machine, the machine further comprising a liquid source in the form of a reservoir comprising a liquid to be introduced to an internal site of a patent during a medical procedure.

29. The system according to claim 1, wherein the system is adapted to provide potable liquid.

30. (canceled)

31. The system according to claim 1, wherein said liquid source is a reservoir comprising wine or juice.

32. A method for separating gas and liquid, including:
supersaturating the liquid;
injecting bubbles into the supersaturated liquid to form a liquid-bubble mixture; and
causing a pressure reduction on the liquid-bubble mixture to separate gas from the liquid.

33. (canceled)

34. The method according to claim 32, wherein said supersaturating is caused by increasing temperature on said liquid in the supersaturation device.

35. (canceled)

36. The method according to claim 32, wherein said liquid a potable liquid.

37. The method according to claim 32, wherein said liquid is a liquid adapted for use in a medical application.
